(19) United States
(12) Patent Application Publication
(10) Pub. No.: US 2020/0257218 A1
(43) Pub. Date: Aug. 13, 2020

(54) DEVELOPMENT ROLLER AND METHOD OF PRODUCING DEVELOPMENT ROLLER

(71) Applicant: BRIDGESTONE CORPORATION, Tokyo (JP)

(72) Inventor: Akihide Osaku, Kawasaki-shi (JP)

(73) Assignee: BRIDGESTONE CORPORATION, Tokyo (JP)

(21) Appl. No.: 16/857,952

(22) Filed: Apr. 24, 2020

Related U.S. Application Data
(63) Continuation of application No. PCT/JP2018/039605, filed on Oct. 25, 2018.

(30) Foreign Application Priority Data
Oct. 26, 2017 (JP) 2017-207514

(51) Int. Cl. G03G 15/08; B32B 7/12; B32B 27/30; C08K 3/36; C09J 11/04; C09J 175/04; C08G 18/10; C08G 18/72; C08F 2/48

(52) U.S. Cl. CPC G03G 15/0818; B32B 7/12; B32B 27/30; C08K 3/36; C09J 11/04; B32B 25/20; C08G 18/10; C08G 18/72; C08F 2/48; C08G 2170/00; C09J 175/04

(57) ABSTRACT

The development roller of the present disclosure includes at least an axis, an elastic layer formed on the axis, and a coating layer formed on the elastic layer, where an adhesive layer is provided between the elastic layer and the coating layer on both ends of the elastic layer in an axial direction of the development roller, the adhesive layer adheres to the elastic layer and the coating layer, and the adhesive layer is a layer obtained by curing a composition for adhesive layer containing a moisture-curable adhesive and a thixotropy-imparting agent.

### TECHNICAL FIELD

This disclosure relates to a development roller and a method of producing a development roller.

### BACKGROUND

In some development rollers, seal members are arranged at both ends in the axial direction of the development roller to prevent toner leakage. In this type of development roller, when the development roller rotates, the ends of the development roller may be worn and the layers forming the development roller may be peeled off.

JP 2008-040241 A (PTL 1) describes a technique for preventing the peeling of layers at the ends of a development roller and reducing the wear at the ends of the development roller, which is achieved by providing an adhesive layer at least one end in the axial direction of the development roller to improve the adhesion between layers.

### CITATION LIST

### Patent Literature

PTL 1: JP 2008-040241 A

### SUMMARY

### Technical Problem

However, when a person attempts to apply an adhesive component with a roll coating method at a uniform thickness to form an adhesive layer as the technique described in PTL 1, the adhesive component drips vertically and therefore the layer cannot be cured at a uniform thickness. As a result, the thickness of the layer at the ends of a roller is uneven, leading to the problem of poor image quality for a development roller.

It could thus be helpful to provide a development roller in which image defects are suppressed while ensuing the adhesiveness between layers. It also could be helpful to provide a method of producing a development roller with which the development roller of the present disclosure can be efficiently produced.

### Solution to Problem

The development roller of the present disclosure includes at least an axis, an elastic layer formed on the axis, and a coating layer formed on the elastic layer, where an adhesive layer is provided between the elastic layer and the coating layer on both ends of the elastic layer in the axial direction of the development roller, the adhesive layer adheres to the elastic layer and the coating layer, and the adhesive layer is a layer obtained by curing a composition for adhesive layer containing a moisture-curable adhesive and a thixotropy-imparting agent.

According to the development roller of the present disclosure, it is possible to suppress image defects while ensuring the adhesiveness between layers.

In the development roller of the present disclosure, the thixotropy-imparting agent is preferably at least one selected from the group consisting of silica, acetylene black, and aliphatic amide.

According to this composition, it is possible to provide a more uniform adhesive layer and further suppress the occurrence of image defects.

In the development roller of the present disclosure, the moisture-curable adhesive preferably contains at least one selected from the group consisting of MDI, prepolymerized MDI, and triphenylmethane triisocyanate, and having two or more isocyanate groups; the elastic layer is preferably urethane foam containing a silicone-based foam stabilizer; and the silicone-based foam stabilizer preferably has a functional group.

According to this composition, by using a silicone-based foam stabilizer, the uniformity of the foam of the obtained elastic body is improved, and the development roller obtains elasticity suitable for a development roller. The use of a silicone-based foam stabilizer generally results in a reduction in the adhesiveness between layers. However, when the above requirements are satisfied, a chemical reaction occurs between the layers, which improves the adhesiveness between the elastic layer and the coating layer.

In the development roller of the present disclosure, the composition for adhesive layer preferably has a thixotropic index (TI value) of 1.8 to 5.0.

According to this composition, it is possible to provide a particularly uniform adhesive layer and particularly suppress the occurrence of image defects.

In the development roller of the present disclosure, the content of the thixotropy-imparting agent in the composition for adhesive layer is preferably 0.5 mass % to 15 mass %.

According to this composition, it is possible to realize high coatability (which is unlikely to be uneven) while the composition for adhesive layer exhibiting sufficient thixotropy.

The method of producing a development roller of the present disclosure is a method of producing the development roller of the present disclosure, comprising: an elastic layer forming step in which a composition for elastic layer is heated to form an elastic layer on the axis; an adhesive layer forming step in which the composition for adhesive layer is applied on both ends of the elastic layer in the axial direction of the development roller to form an adhesive layer; and a coating layer forming step in which a composition for coating layer is applied on the elastic layer formed in the elastic layer forming step and the adhesive layer formed in the adhesive layer forming step, and then the applied composition for coating layer is cured to form a coating layer.

According to the method of producing a development roller of the present disclosure, it is possible to efficiently produce the development roller of the present disclosure.

### Advantageous Effect

According to the present disclosure, it is possible to provide a development roller in which image defects are suppressed while ensuring the adhesiveness between layers. In addition, according to the present disclosure, it is possible to provide a method of producing a development roller with which the development roller of the present disclosure can be efficiently produced.

### BRIEF DESCRIPTION OF THE DRAWINGS

In the accompanying drawing:

FIG. 1 is a cross-sectional view of an embodiment of the development roller of the present disclosure.

### DETAILED DESCRIPTION

The following provides a description of an embodiment of the present disclosure with reference to the drawing as necessary.

(Development Roller)

The development roller of the present disclosure includes at least an axis, an elastic layer formed on the axis, and a coating layer formed on the elastic layer.

In the development roller of the present disclosure, an adhesive layer is provided between the elastic layer and the coating layer at both ends of the elastic layer in the axial direction of the development roller.

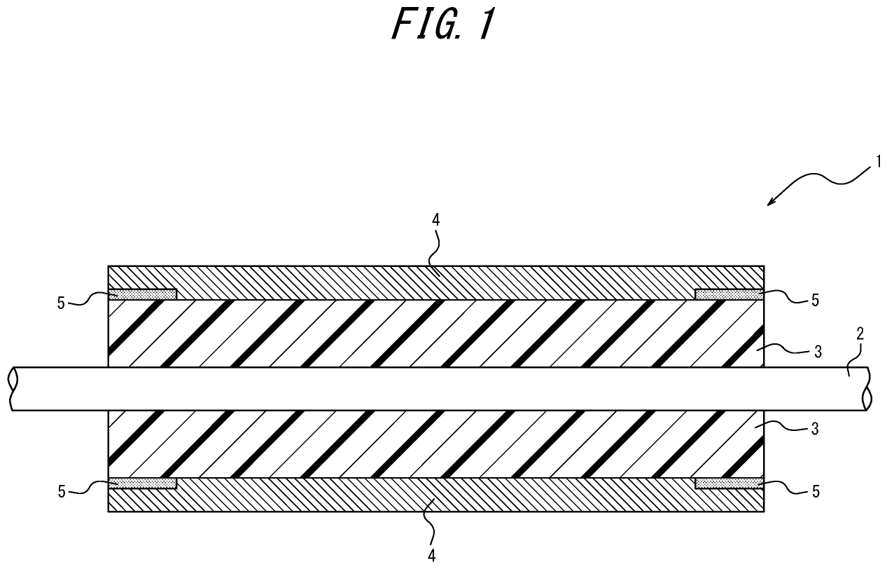

FIG. 1 is a cross-sectional view of an embodiment of the development roller of the present disclosure. The development roller 1 illustrated in FIG. 1 includes an axis 2 that is attached by being axially supported at both ends in the length direction by flanges, which are not illustrated in the drawing, and an elastic layer 3 disposed radially outside the axis 2. In addition, the development roller 1 illustrated in FIG. 1 includes a coating layer 4 adjacent to the elastic layer 3 radially outside. Further, the development roller 1 illustrated in FIG. 1 includes an adhesive layer 5 between the elastic layer 3 and the coating layer 4 at both ends of the elastic layer 3 in the axial direction.

In the case where a composition for adhesive layer is applied on the elastic layer with a roll coating method, if the viscosity of the composition for adhesive layer is low, the applied composition for adhesive layer drips vertically. As a result, it is impossible to form an adhesive layer having a uniform thickness. On the other hand, if the viscosity of the composition for adhesive layer is high, the stirring efficiency during the preparation of the composition for adhesive layer decreases, and it is difficult to control the application of the composition for adhesive layer. As a result, the working efficiency decreases. With respect to the viscosity of the composition for adhesive layer, it has been found difficult to prevent dripping while maintaining the working efficiency under a single viscosity condition.

As a result of intensive study, we have found that adding silica to a composition for adhesive layer mainly composed of a moisture-curable adhesive imparts thixotropy to the composition for adhesive layer. Thixotropy is a physical property of having a high viscosity at rest and becoming less viscous only when, for example, being stirred. We have focused on the fact that the viscosity condition of the composition for adhesive layer can be appropriately adjusted utilizing the thixotropy, and have found a technical idea of, according to the content of work during the production, decreasing the viscosity during the application and stirring to increase the workability, and increasing the viscosity after the application to prevent dripping, thereby completing the present disclosure.

Because the adhesive layer of the development roller of the present disclosure has a uniform thickness, the development roller has a uniform thickness. When the thickness is uniform, the quantity of toner transferred from the development roller to a photoreceptor is constant, which suppresses image defects.

In addition, because the development roller of the present disclosure has an adhesive layer at the ends in the axial direction of the development roller where wear is likely to occur, the peeling of layers at the end is suppressed, and the adhesiveness between layers is ensured.

<Elastic Layer>

The elastic layer is a layer having elasticity formed on the axis in the development roller of the present disclosure. The elastic layer is formed by heating a composition for elastic layer.

The elastic layer is not particularly limited and can be appropriately selected depending on the purpose. Examples thereof include a polyurethane resin, a rubber elastic body, a polyamide resin, a polyester resin, a polyimide resin, a silicone resin, an acrylic resin, a polyvinylidene fluoride resin, a polyvinyl butyral resin, an ethylene-tetrafluoroethylene copolymer resin, a melamine resin, a fluororesin, an epoxy resin, a polycarbonate resin, a polyvinylalcohol resin, a cellulose resin, a polyvinylidene chloride resin, a polyvinyl chloride resin, a polyethylene resin, and an ethylene-vinyl acetate copolymer resin. These may be used alone or in combination of two or more.

Among these, a polyurethane resin is preferable in that it has elasticity suitable for a development roller.

<<Polyurethane Resin>>>

The polyurethane resin can be obtained by subjecting a polyol and an isocyanate to a polyaddition reaction with a known reaction method. The polyurethane resin is not particularly limited and can be appropriately selected depending on the purpose. Examples thereof include polyurethane foam obtained by foaming with a foam stabilizer, and non-foamed polyurethane obtained without foaming. These may be used alone or in combination of two or more.

Among these, polyurethane foam is advantageous in that it has elasticity particularly suitable for a development roller.

<<Rubber Elastic Body>>

The rubber elastic body is not particularly limited and can be appropriately selected depending on the purpose. Examples thereof include natural rubber, isoprene rubber, chloroprene rubber, epichlorohydrin rubber, butyl rubber, fluororubber, styrene-butadiene rubber, butadiene rubber, nitrile rubber, ethylene-propylene rubber, epichlorohydrin-ethylene oxide copolymer rubber, epichlorohydrin-ethylene oxide-allyl glycidyl ether copolymer rubber, ethylene-propylene-diene terpolymer rubber (EPDM), acrylonitrile-butadiene copolymer rubber (NBR), and rubber blended of them. These may be used alone or in combination of two or more.

<<Composition for Elastic Layer>>

The composition for elastic layer is not particularly limited as long as it is a composition capable of forming the elastic layer, and the composition for elastic layer can be appropriately selected depending on the purpose.

In the case of forming an elastic layer of the polyurethane resin, the composition for elastic layer preferably contains components such as a polyol, an isocyanate, a urethane bond catalyst, a solvent, and a filler. In the case of forming an elastic layer of the polyurethane foam, it is preferable to further contain a foam stabilizer.

In addition to the above-mentioned components, the composition for elastic layer may optionally contain an ion conductive agent, a plasticizer, a softener, a tackifier, an anti-blocking agent, a separating agent, a mold release agent, an extender, a colorant, a crosslinking agent, a vulcanizing agent, a polymerization inhibitor, and the like.

—Polyol—

The polyol is not particularly limited and can be appropriately selected depending on the purpose. Examples thereof include polyether polyol, polyester polyol, polytetramethylene glycol, polybutadiene polyol, alkylene oxide-modified polybutadiene polyol, and polyisoprene polyol. These may be used alone or in combination of two or more.

Among these, polyether polyol is preferable in terms of resin flexibility and low permanent compression strain.

—Isocyanate—

The isocyanate is not particularly limited and can be appropriately selected depending on the purpose. Examples thereof include tolylene diisocyanate (TDI), prepolymerized tolylene diisocyanate (prepolymerized TDI), diphenylmethane diisocyanate (MDI), crude diphenylmethane diisocyanate (crude MDI), isophorone diisocyanate (IPDI), hydrogenated diphenylmethane diisocyanate, hydrogenated tolylene diisocyanate, hexamethylene diisocyanate (HDI); and their isocyanurate-modified products, carbodiimide-modified products, and glycol-modified products. These may be used alone or in combination of two or more.

Among these, prepolymerized tolylene diisocyanate (prepolymerized TDI) is preferable because it has high urethane reaction activity and easily improves the elasticity of the elastic layer and thus the elasticity of the development roller.

—Urethane Bond Catalyst—

The urethane bond catalyst is not particularly limited and can be appropriately selected depending on the purpose. Examples thereof include dibutyltin dilaurate, dioctyltin acetate, dioctyltin bis (ethyl malate), dibutyltin bis (oleyl malate), dibutyltin diacetate, dibutyltin thiocarboxylate, dibutyltin dimalate, dioctyltin thiocarboxylate, tin octenoate, and monobutyltin oxide. These may be used alone or in combination of two or more.

Among these, dibutyltin dilaurate is preferable because of its high catalytic activity.

—Solvent—

The solvent is not particularly limited and can be appropriately selected depending on the purpose. Examples thereof include butyl acetate; alcohols such as methanol, ethanol and isopropyl alcohol; dimethyl sulfone; dimethyl sulfoxide; tetrahydrofuran; dioxane; toluene; and xylene. These may be used alone or in combination of two or more.

Among these, butyl acetate is preferable because of its high volatilization rate.

—Foam Stabilizer—

The foam stabilizer is not particularly limited and can be appropriately selected depending on the purpose. Examples thereof include a silicone-based foam stabilizer, an ionic surfactant, and a nonionic surfactant. These may be used alone or in combination of two or more.

Among these, a silicone-based foam stabilizer is preferable from the viewpoint of improving the foam uniformity of the foam. On the other hand, using a silicone-based foam stabilizer in the composition for elastic layer may reduce the adhesiveness with other adjacent layers.

The silicone-based foam stabilizer preferably has a functional group. The functional group of the silicone-based foam stabilizer is not particularly limited and can be appropriately selected depending on the purpose. Examples thereof include a OH (hydroxyl) group, a thiol group, an amino group, an imino group, a nitro group, a nitroso group, a carboxyl group, an acryloyl group, an alkyl group, an alkenyl group, and an alkoxy group. These may be used alone or in combination of two or more.

Among these, a OH (hydroxyl) group is preferable in that, when the composition for adhesive layer contains an isocyanate as described later, the isocyanate forms a urethane bond with the OH (hydroxyl) group derived from the silicone-based foam stabilizer of the elastic layer, so that the adhesiveness between the elastic layer and the adhesive layer can be further improved. In the case where the moisture-curable adhesive contains MDI having two or more isocyanate groups described later, because the MDI has high electron withdrawing property and easily reacts chemically with the OH of the foam stabilizer, the reaction efficiency is high and the adhesiveness can be particularly improved.

<<Thickness of Elastic Layer>>

The thickness of the elastic layer is not particularly limited and can be appropriately selected depending on the purpose. However, it is preferably 0.5 μm to 7.0 μm.

<Adhesive Layer>

The adhesive layer is a layer provided between the elastic layer and the coating layer at both ends of the elastic layer in the axial direction of the development roller.

The adhesive layer is a layer obtained by curing a composition for adhesive layer containing a moisture-curable adhesive and a thixotropy-imparting agent.

The adhesive layer adheres to the elastic layer and the coating layer.

<<Both Ends>>

As used herein, the “end of the elastic layer” means a portion including the end of the elastic layer in the axial direction. Since there are two ends in the axial direction of the development roller of the present disclosure, the “both ends” used herein means two ends.

The length of each end in the axial direction is not particularly limited and can be appropriately selected depending on the purpose. For example, when the length of the elastic layer in the axial direction is 1, the length may be ¼ or less, 1/10 or less, 1/20 or less, 1/40 or less, or 1/80 or less.

When a seal member is arranged at a part contacting the end of the development roller as a component of a toner cartridge for electrophotography, by appropriately selecting the width of the adhesive layer at the end provided in the present disclosure according to the length of the part where the seal member contacts the development roller, it is possible to efficiently avoid the peeling of layers that tends to occur due to the friction between the development roller and the seal member and to extend the product life of the development roller. Specifically, when the length of the adhesive layer at the end in the axial direction is in the range of +1 mm to +15 mm with respect to the part contacting the arranged seal member, it is effective in extending the product life of the development roller.

<<Composition for Adhesive Layer>>

The composition for adhesive layer contains at least a moisture-curable adhesive and a thixotropy-imparting agent and may contain other components as necessary.

—Moisture-Curable Adhesive—

In the moisture-curable adhesive, moisture leads to a curing reaction (crosslinking reaction) and adheres two or more adherends.

The moisture-curable adhesive is not particularly limited and can be appropriately selected depending on the purpose. Examples thereof include a silicone resin, a urethane resin, an epoxy resin, and an acrylic resin. These may be used alone or in combination of two or more.

When the moisture-curable adhesive contains MDI having two or more isocyanate groups, the adhesive easily reacts chemically with the functional group of the foam stabilizer, which particularly improves the adhesiveness. Therefore, a moisture-curable adhesive containing MDI having two or more isocyanate groups is advantageous.

—MDI Having Two or More Isocyanate Groups—

The compound having two or more isocyanate groups is not particularly limited and can be appropriately selected depending on the purpose. Preferable examples thereof include MDI (diphenylmethane diisocyanate), prepolymerized MDI, and triphenylmethane triisocyanate.

The MDI is not particularly limited and can be appropriately selected depending on the purpose. Examples thereof include 2,2′-MDI, 2,4′-MDI, 4,4′-MDI, and polymeric MDI. The prepolymerized MDI is preferably one obtained by reacting MDI with a bifunctional or higher functional polyol at an isocyanate index of 1.5 or more.

Among the above-mentioned compounds, 4,4′-MDI, prepolymerized 4,4′-MDI, and triphenylmethane triisocyanate are more preferable from the viewpoint of rapid reaction and adhesiveness.

—Thixotropy-Imparting Agent—

Thixotropy is a physical property of having a high viscosity at rest and becoming less viscous only when, for example, being stirred.

When the composition for adhesive layer contains the thixotropy-imparting agent, the thixotropy of the composition for adhesive layer is improved, and the composition for adhesive layer will not drip vertically after being applied on the elastic layer.

The thixotropy-imparting agent is not particularly limited and can be appropriately selected depending on the purpose. Examples thereof include silica, acetylene black, and aliphatic amide. These may be used alone or in combination of two or more.

Among these, silica and acetylene black are preferable in terms of bleeding out.

—Silica—

The silica is not particularly limited and can be appropriately selected depending on the purpose. Examples thereof include silica having a hydroxyl group on the surface and silica having surface absorption. These may be used alone or in combination of two or more.

Among these, silica having a hydroxyl group is preferable because in this case, thixotropy can be easily obtained even with a small amount of addition.

—Content of Thixotropy-Imparting Agent—

The content (mass %) of the thixotropy-imparting agent in the composition for adhesive layer is not particularly limited and can be appropriately selected depending on the purpose. It is preferably 0.5 mass % to 15 mass % and more preferably 0.5 mass % to 10 mass %.

The content of the thixotropy-imparting agent in the composition for adhesive layer is preferably 0.5 mass % or more because in this case, the composition for adhesive layer exhibits sufficient thixotropy. The content is preferably 15 mass % or less in terms of coatability (which is unlikely to be uneven). For the same reason, it is more advantageous that the content of the thixotropy-imparting agent in the composition for adhesive layer be within the above-mentioned more preferable range and within the above-mentioned particularly preferable range.

—Other Components Optionally Contained in Composition for Adhesive Layer—

The other components optionally contained in the composition for adhesive layer are not particularly limited and can be appropriately selected depending on the purpose. Examples thereof include a photopolymerization initiator, a photopolymerization initiation aid, minute particles, an ion conductive agent, a filler, a peptizer, a foaming agent, a plasticizer, a softener, a tackifier, an anti-blocking agent, a separating agent, a mold release agent, an extender, a colorant, a crosslinking agent, a vulcanizing agent, and polymerization inhibitor. These may be used alone or in combination of two or more.

—Thixotropic Index (TI Value)—

The thixotropic index (TI) of the composition for adhesive layer is not particularly limited and can be appropriately selected depending on the purpose. However, it is preferably 1.8 to 5.0, more preferably 2.0 to 5.0, and particularly preferably 2.0 to 4.0.

When the thixotropic index is 1.8 or more, thixotropy is imparted to the composition for adhesive layer, stirring of the composition for adhesive layer is facilitated, and preparation time of the composition for adhesive layer can be shortened. As a result, the workability is improved. In addition, it is easy to apply a uniform layer during the application. Further, the composition for adhesive layer becomes more viscous after the application, which prevents the composition for adhesive layer from dripping vertically from the roller. The thixotropic index is preferably 5.0 or less because in this case, the coatability is excellent and the application can be performed evenly. For the same reason, it is more advantageous that the thixotropic index be within the above-mentioned more preferable range and within the above-mentioned particularly preferable range.

The thixotropic index (TI value) is obtained by measuring the viscosity of the composition for adhesive layer at 25° C. using a B-type viscometer made by Toki Sangyo Co., Ltd. (product name: TVB-15), taking the viscosity value measured at a rotation speed of 30 rpm as A and the viscosity value measured at a rotation speed of 6 rpm as B, and calculating the value of B/A.

<<Thickness of Adhesive Layer>>

The thickness of the adhesive layer is not particularly limited and can be appropriately selected depending on the purpose. However, it is preferably 0.2 μm to 20 μm, more preferably 0.2 μm to 10 μm, and particularly preferably 0.2 μm to 5 μm from the viewpoint of maintaining high adhesiveness while realizing a thin layer.

<Coating Layer>

The coating layer is a layer formed on the elastic layer and, if an adhesive layer is provided on the elastic layer, on the adhesive layer. The coating layer is formed by curing a composition for coating layer.

The coating layer is not particularly limited and can be appropriately selected depending on the purpose. Examples thereof include a polyurethane resin, an acrylic resin, a rubber elastic body, a polyamide resin, a polyester resin, a polyimide resin, a silicone resin, a polyvinylidene fluoride resin, a polyvinyl butyral resin, an ethylene-tetrafluoroethylene copolymer resin, a melamine resin, a fluororesin, an epoxy resin, a polycarbonate resin, a polyvinylalcohol resin, a cellulose resin, a polyvinylidene chloride resin, a polyvinyl chloride resin, a polyethylene resin, and an ethylene-vinyl acetate copolymer resin. These may be used alone or in combination of two or more.

Among these, a polyurethane resin is preferable in that it has elasticity suitable for a development roller. In particular, a urethane acrylate resin is more preferable in terms of production efficiency because it can be cured by irradiation with energy rays.

<<Composition for Coating Layer>>

The composition for coating layer is not particularly limited as long as it is a composition capable of forming the coating layer, and the composition for coating layer can be appropriately selected as necessary.

In the case of forming a coating layer of the urethane acrylate resin, the composition for coating layer preferably contains components such as an ultraviolet-curable urethane acrylate, a photopolymerization initiator, a filler, and a solvent.

The composition for coating layer may contain, in addition to the above-mentioned components, an ion conductive agent, a peptizer, a plasticizer, a softener, a tackifier, an anti-blocking agent, a separating agent, a mold release agent, an extender, a colorant, a crosslinking agent, a vulcanizing agent, a polymerization inhibitor, and the like as necessary.

—Ultraviolet-Curable Urethane Acrylate—

The ultraviolet-curable urethane acrylate is not particularly limited and can be appropriately selected depending on the purpose. Examples thereof include ultraviolet-curable aliphatic urethane acrylate and ultraviolet-curable aromatic urethane acrylate. These may be used alone or in combination of two or more.

—Photopolymerization Initiator—

The photopolymerization initiator is not particularly limited and can be appropriately selected depending on the purpose. Examples thereof include an alkylphenone-based photopolymerization initiator, an acylphosphine oxide-based photopolymerization initiator, and an oxime ester-based photopolymerization initiator. These may be used alone or in combination of two or more.

<<Thickness of Coating Layer>>

The thickness of the coating layer is not particularly limited and can be appropriately selected depending on the purpose. However, the thickness on the adhesive layer is preferably 0.5 μm to 40 μm, more preferably 0.5 μm to 20 μm, and particularly preferably 0.5 μm to 10 μm.

<Axis>

The axis is not particularly limited and can be appropriately selected depending on the purpose. Examples thereof include a hollow cylinder or solid cylinder made of metal or resin.

(Method of Producing Development Roller)

The method of producing a development roller of the present disclosure is a method of producing the above-described development roller, including at least an elastic layer forming step, an adhesive layer forming step performed after the elastic layer forming step, and a coating layer forming step performed after the adhesive layer forming step. The method may further include other steps as necessary.

According to the method of producing a development roller of the present disclosure, the development roller of the present disclosure can be efficiently produced.

<Elastic Layer Forming Step>

The elastic layer forming step is a step of heating a composition for elastic layer to form an elastic layer on the axis.

The constitution of the elastic layer and the composition of the composition for elastic layer are as described above.

The method of forming the elastic layer is not particularly limited as long as the composition for elastic layer is heated, and the method can be appropriately selected depending on the purpose. For example, in the heat treatment, irradiation of energy rays such as ultraviolet rays, infrared rays, visible light, and electron beams may be combined to obtain an elastic layer.

The elastic layer may be formed by filling the composition for elastic layer into a mold in which the axis is arranged and heating the composition in the mold, or may be formed by applying the composition for elastic layer to the surface of the axis and then heating the composition.

<<Heating>>

The heating method is not particularly limited and can be appropriately selected depending on the purpose. Examples thereof include oven heating.

The heating conditions are not particularly limited, and the heating temperature, heating time, and the like can be appropriately selected according to the components contained in the composition, the composition of the composition, the application amount of the composition, and the like.

<<Ultraviolet Irradiation>>

The light source used for the ultraviolet irradiation is not particularly limited and can be appropriately selected depending on the purpose. Examples thereof include a mercury lamp, a high-pressure mercury lamp, an ultra-high-pressure mercury lamp, a metal halide lamp, and a xenon lamp.

The conditions of the ultraviolet irradiation are not particularly limited, and the irradiation intensity, integrated light amount, and the like can be appropriately selected according to the components contained in the composition, the composition of the composition, the application amount of the composition, and the like.

<Adhesive Layer Forming Step>

The adhesive layer forming step is a step of applying the composition for adhesive layer on both ends of the elastic layer in the axial direction of the development roller to form an adhesive layer.

The constitution of the adhesive layer and the composition of the composition for adhesive layer are as described above.

Since the composition for adhesive layer contains a moisture-curable adhesive, it cures in the presence of moisture. However, it may be cured further in combination with, for example, heat treatment and irradiation with energy rays such as ultraviolet rays, infrared rays, visible light, and electron beams.

<<Application>>

The method of applying the composition for adhesive layer is not particularly limited and can be appropriately selected depending on the purpose. Examples thereof include a roll coating method, a spraying method, a dipping method, and a die coating method. These may be used alone or in combination of two or more.

—Roll Coating Method—

The roll coating method is not particularly limited and can be appropriately selected depending on the purpose. The application method according to the roll coating method may be a method of pressing a roll that holds the composition for adhesive layer against the surface of the elastic layer and rolling the roll against the elastic layer to apply the composition for adhesive layer, for example.

<Coating Layer Forming Step>

The coating layer forming step is a step of applying the composition for coating layer on the elastic layer formed in the elastic layer forming step and the adhesive layer formed in the adhesive layer forming step and then curing the applied composition for coating layer to form a coating layer.

The constitution of the coating layer and the composition of the composition for coating layer are as described above.

The method of forming the coating layer is not particularly limited and can be appropriately selected depending on the purpose. Examples thereof include heat treatment and irradiation of energy rays such as ultraviolet rays, infrared rays, visible light, and electron beams. These may be used alone or in combination of two or more.

<<Application>>

The method of applying the composition for coating layer is not particularly limited and can be appropriately selected depending on the purpose. Examples thereof include a roll coating method, a spraying method, a dipping method, and a die coating method. These may be used alone or in combination of two or more.

Among these, a roll coating method is preferable from the viewpoint of the uniformity of the coating.

<Other Steps>

The other steps are not particularly limited and can be appropriately selected depending on the purpose. Examples thereof include an elastic layer and coating layer cleaning step.

### EXAMPLES

The following provides a more detailed description of the present disclosure through examples. However, the present disclosure is not in any way limited by the following examples and can be modified in an appropriate manner without departing from the scope and spirit thereof.

### Examples 1 to and Comparative Examples 1 to 2

Development rollers were prepared with the following method.

<Preparation of Prepolymerized TDI>

In a three-necked flask, EXCENOL 5030 (made by Asahi Glass Co., Ltd.) and TDI (made by Mitsui Chemicals Co., Ltd.) were blended so that the isocyanate index (number of NCO moles/number of OH moles) was 4.5, and the mixture was heated at a liquid temperature of 70° C. for 2 hours using a heating mantle. After the disappearance of polyol was confirmed with a hydroxyl value method, prepolymerized TDI was obtained.

<Preparation of Composition for Elastic Layer>

The following were blended to obtain a polyol mixture: 2000 parts by mass of SANNIX FA-951 (made by Sanyo Chemical Industries, Ltd.) as a polyol, 5000 parts by mass of KURARAY POLYOL F-510 (made by Kuraray Co., Ltd.) as a polyol, 2000 parts by mass of KURARAY POLYOL F-1010 (made by Kuraray Co., Ltd.) as a polyol, 650 parts by mass of LIGHT ESTER HOA (made by Kyoeisha Chemical Co., Ltd.) which was acrylate having a hydroxyl group, 10 parts by mass of NEOSTANN U-100 (made by Nitto Kasei Co., Ltd.) as a urethane bond catalyst, and 410 parts by mass of SF2937F (made by Dow Corning Toray Co., Ltd.) as a silicone-based foam stabilizer.

The following were blended to obtain an isocyanate mixture: 20000 parts by mass of the above-prepared prepolymerized TDI (isocyanate group %=7%) as an isocyanate and 600 parts by mass of DENKA BLACK (made by DENKI KAGAKU KOGYO KABUSHIKI KAISHA) as a filler.

Then, the polyol mixture and the isocyanate mixture were set in separate tanks and injected into a mechanical floss injection tank at a controlled flow rate so that the isocyanate index was 1.1.

<Formation of Elastic Layer>

The composition for elastic layer was poured into a φ20 mold in which an axis was arranged, the composition was heated at 120° C. for 30 minutes using an oven, and a cured elastic layer was taken out of the mold.

<Preparation of Composition for Adhesive Layer>

In Examples 1 to the moisture-curable adhesive and the thixotropy-imparting agent listed in Table 1 were blended in the amounts listed in Table 1 in a 300 ml SUS beaker. Further, 50 parts by mass of butyl acetate as a solvent was added to the SUS beaker, and the mixture was stirred at 1500 rpm for 20 minutes using a homogenizing disperser. Butyl acetate was further added until the viscosity of the solution in the SUS beaker was 20±5 mPa·s, and a composition for adhesive layer was obtained. The viscosity of the solution was measured using a B-type viscometer (TVB-15) made by Toki Sangyo Co., Ltd. The measurement was performed on the solution at 25° C. at a rotation speed of 30 rpm using a low viscosity adapter.

In Comparative Example 1, because the viscosity of OCM-50 (made by ASIA INDUSTRY CO., LTD., solid content: 21%) was low, the OCM-50 was used as the composition for adhesive layer as it was without being diluted with butyl acetate. The numerical value of the blending amount of OCM-50 in Table 1 indicates the solid component in OCM-50 in parts by mass.

In Comparative Example 2, the moisture-curable adhesive listed in Table 1 was blended in the amount listed in Table 1 in a 300 ml SUS beaker, and the other conditions were the same as those in Examples 1 to. The composition for adhesive layer was prepared in this way.

<Thixotropic Index (TI Value)>

The thixotropic index (TI value) of the obtained composition for adhesive layer was obtained by measuring the viscosity of the composition for adhesive layer at 25° C. using a B-type viscometer made by Toki Sangyo Co., Ltd. (product name: TVB-15), taking the viscosity value measured at a rotation speed of 30 rpm as A and the viscosity value measured at a rotation speed of 6 rpm as B, and calculating the value of B/A. The results of the thixotropic index of the composition for adhesive layer are listed in Table 1. A higher thixotropic index value means higher thixotropy.

<Formation of Adhesive Layer>

The composition for adhesive layer was applied on both ends of the elastic layer in the axial direction with a roll coating method to form an adhesive layer. The composition for adhesive layer was applied on the elastic layer in a thickness of 0.2 μm to 5 μm.

<Preparation of Composition for Coating Layer>

The following were blended and stirred to prepare a composition for coating layer: 100 parts by mass of UV-3200B (made by Nippon Synthetic Chemical Industry Co., Ltd.) as an ultraviolet-curable urethane acrylate, 0.5 parts by mass of IRGACURE907 (made by BASF) as a photopolymerization initiator, 0.5 parts by mass of IRGACURE819 (made by BASF) as a photopolymerization initiator, 12 parts by mass of Art Pearl C800 (made by Negami chemical industrial co., ltd) as a filler, and 200 parts by mass of butyl acetate as a solvent.

<Formation of Coating Layer>

The obtained composition for coating layer was applied on the elastic layer and, if an adhesive layer was provided on the elastic layer, on the adhesive layer with a roll coating method. The coating was applied on the adhesive layer in a thickness of 0.5 μm to 10 μm. The applied composition for coating layer was cured using an ultraviolet device D-bulb made by Fusion to form a coating layer, thereby obtaining a development roller.

The adhesiveness between layers was evaluated by the following cross-cut test. The results are listed in Table 1.

<Cross-Cut Test>

A member composed of the elastic layer and the adhesive layer (hereinafter referred to as a laminated member) was cut into twenty-five squares measuring 2 mm×2 mm wide in 5 columns and 5 rows. Cellophane tape No. 29 made by Nitto Denko Corporation was pressed firmly onto the squares with a finger and quickly peeled off. Any square that even partially peeled was deemed to have peeled, and the number of squares that did not peel was counted. A laminated member for which no square peeled was “25/25”. A larger number indicates higher adhesiveness, and “25/25” means that the development roller can keep excellent adhesiveness.

<Evaluation of Layer Uniformity>

The uniformity of the layers forming the development roller was evaluated by observing the cross section of the obtained development roller. The layer uniformity was determined based on whether or not the thickness of the adhesive layer was uniform. The layer uniformity was evaluated in two stages: good (the thickness was uniform) and poor (the thickness was not uniform). When it is evaluated as good, it can be said that image defects hardly occur in the development roller.

TABLE 1

| | | | Comparative | Comparative | | | | | |
|---|---|---|---|---|---|---|---|---|---|
| | | | Example | Example | Example | Example | Example | Example | Example |
| | Coating material name | | 1 | 2 | 1 | 2 | 3 | 4 | 5 |
| Composition | Moisture-curable | PD-200 *1 | — | 100 | 100 | 100 | 100 | — | 100 |
| for | adhesive | Desmodur RE *8 | — | — | — | — | — | 100 | — |
| adhesive | | OCM-50 *2 | 100 | — | — | — | — | — | — |
| layer | Thixotropy- | BYK-3650 *4 | — | — | 0.5 | — | — | — | — |
| | imparting | PMA-ST *5 | — | — | — | 0.5 | — | 0.5 | 15 |
| | agent | PMA-STL *6 | — | — | — | — | 0.5 | — | — |
| Evaluation | Composition for | TI value | 1.1 | 1.1 | 1.9 | 1.9 | 2.1 | 2.0 | 5.0 |
| | adhesive layer | | | | | | | | |
| | Laminated member | Cross-cut test | 2/25 | 25/25 | 25/25 | 25/25 | 25/25 | 25/25 | 25/25 |
| | Development roller | Evaluation of | Poor | Poor | Good | Good | Good | Good | Good |
| | | layer uniformity | | | | | | | |

*1: PD-200: MDI-based moisture-curable primer (made by ASIA INDUSTRY CO., LTD.)
*2: OCM-50: aliphatic isocyanate-based moisture-curable primer (made by ASIA INDUSTRY CO., LTD.)
*4: BYK-3650: organic solvent dispersed nano silica (made BYK Japan KK)
*5: PMA-ST: organic solvent dispersed nano silica (made by Nissan Chemical Industries, Ltd.)
*6: PMA-STL: organic solvent dispersed nano silica (made by DENKI KAGAKU KOGYO KABUSHIKI KAISHA)
*8: Desmodur ® RE (Desmodur is a registered trademark in Japan, other countries, or both): ethyl acetate solution of triphenylmethane triisocyanate (made by Sumika Covestro Urethane Co., Ltd.)

It is understood by comparing Comparative Examples 1 to 2 and Examples 1 to 5 that the presence of MDI, or prepolymerized MDI or triphenylmethane triisocyanate as a moisture-curable adhesive has an important effect on adhesiveness.

It is understood by comparing Comparative Example 2 and Examples 1 to 3 that the addition of a thixotropy-imparting agent is important for the uniformity of phase and is necessary for exhibiting the effects of the present disclosure.

It is understood that, in Examples 1 to 5, the composition for adhesive layer could be easily applied. In addition, no dripping was found immediately after the application.

### INDUSTRIAL APPLICABILITY

According to the present disclosure, it is possible to provide a development roller in which image defects are suppressed while ensuring the adhesiveness between layers. In addition, according to the present disclosure, it is possible to provide a method of producing a development roller with which the development roller of the present disclosure can be efficiently produced.

### REFERENCE SIGNS LIST

1 development roller
2 axis
3 elastic layer
4 coating layer
5 adhesive layer

1. A development roller, comprising at least an axis, an elastic layer formed on the axis, and a coating layer formed on the elastic layer, wherein
an adhesive layer is provided between the elastic layer and the coating layer on both ends of the elastic layer in an axial direction of the development roller,
the adhesive layer adheres to the elastic layer and the coating layer, and
the adhesive layer is a layer obtained by curing a composition for adhesive layer containing a moisture-curable adhesive and a thixotropy-imparting agent.

2. The development roller according to claim 1, wherein the thixotropy-imparting agent is at least one selected from the group consisting of silica, acetylene black, and aliphatic amide.

3. The development roller according to claim 1, wherein
the moisture-curable adhesive contains at least one selected from the group consisting of MDI, prepolymerized MDI, and triphenylmethane triisocyanate, and having two or more isocyanate groups,
the elastic layer is urethane foam containing a silicone-based foam stabilizer, and
the silicone-based foam stabilizer has a functional group.

4. The development roller according to claim 1, wherein the composition for adhesive layer has a thixotropic index, which is represented as TI value, of 1.8 to 5.0.

5. The development roller according to claim 1, wherein a content of the thixotropy-imparting agent in the composition for adhesive layer is 0.5 mass % to 15 mass %.

6. A method of producing a development roller, which is a method of producing the development roller according to claim 1, comprising:
an elastic layer forming step in which a composition for elastic layer is heated to form an elastic layer on the axis,
an adhesive layer forming step in which the composition for adhesive layer is applied on both ends of the elastic layer in the axial direction of the development roller to form an adhesive layer, and
a coating layer forming step in which a composition for coating layer is applied on the elastic layer formed in the elastic layer forming step and the adhesive layer formed in the adhesive layer forming step, and then the applied composition for coating layer is cured to form a coating layer.

7. The development roller according to claim 3, wherein the functional group of the silicone-based foam stabilizer is OH group.

8. The development roller according to claim 1, wherein the coating layer contains ultraviolet-curable aliphatic urethane acrylate.

9. The development roller according to claim 2, wherein
the moisture-curable adhesive contains at least one selected from the group consisting of MDI, prepolymerized MDI, and triphenylmethane triisocyanate, and having two or more isocyanate groups,
the elastic layer is urethane foam containing a silicone-based foam stabilizer, and
the silicone-based foam stabilizer has a functional group.

10. The development roller according to claim 2, wherein the composition for adhesive layer has a thixotropic index, which is represented as TI value, of 1.8 to 5.0.

11. The development roller according to claim 2, wherein a content of the thixotropy-imparting agent in the composition for adhesive layer is 0.5 mass % to 15 mass %.

12. The development roller according to claim 2, wherein the coating layer contains ultraviolet-curable aliphatic urethane acrylate.

13. The development roller according to claim 3, wherein the composition for adhesive layer has a thixotropic index, which is represented as TI value, of 1.8 to 5.0.

14. The development roller according to claim 3, wherein a content of the thixotropy-imparting agent in the composition for adhesive layer is 0.5 mass % to 15 mass %.

15. The development roller according to claim 3, wherein the coating layer contains ultraviolet-curable aliphatic urethane acrylate.

16. The development roller according to claim 4, wherein a content of the thixotropy-imparting agent in the composition for adhesive layer is 0.5 mass % to 15 mass %.

17. The development roller according to claim 4, wherein the coating layer contains ultraviolet-curable aliphatic urethane acrylate.

18. The development roller according to claim 5, wherein the coating layer contains ultraviolet-curable aliphatic urethane acrylate.

19. The development roller according to claim 7, wherein the coating layer contains ultraviolet-curable aliphatic urethane acrylate.
